(19) United States
(12) Patent Application Publication
(10) Pub. No.: US 2026/0180421 A1
(43) Pub. Date: Jun. 25, 2026

(54) MULTI-OUTPUT VOLTAGE REGULATOR (VR) TOPOLOGIES

(71) Applicants: Nachiket Desai, Portland, OR (US); Harish K. Krishnamurthy, Beaverton, OR (US); Mausamjeet Khatua, Hillsboro, OR (US)

(72) Inventors: Nachiket Desai, Portland, OR (US); Harish K. Krishnamurthy, Beaverton, OR (US); Mausamjeet Khatua, Hillsboro, OR (US)

(21) Appl. No.: 18/990,846

(22) Filed: Dec. 20, 2024

(51) Int. Cl. H02M 1/00; H02M 3/00; H02M 3/158

(52) U.S. Cl. CPC H02M 1/0048; H02M 3/003; H02M 3/158

(57) ABSTRACT

An apparatus includes a first voltage divider circuit coupled to an input voltage terminal supplying an input voltage signal. The first voltage divider circuit is to generate a first intermediate voltage signal based on the input voltage signal. The apparatus includes a first voltage converter circuit coupled to the first voltage divider circuit. The first voltage converter circuit generates a first output voltage signal based on the first intermediate voltage signal and supplies the first output voltage signal to a first output voltage terminal. The apparatus includes a second voltage converter circuit coupled to the first voltage divider circuit and the first voltage converter circuit. The second voltage converter circuit generates a second output voltage signal on a second output voltage terminal based on the first intermediate voltage signal.

### BACKGROUND

Power demands of artificial intelligence (AI) based computing architectures are outpacing the capability of traditional power delivery systems. The increasing power requirements of such architectures, coupled with the increased number of voltage rails in the modern AI accelerator platforms, warrant an overhaul in the power delivery architecture of the graphics processing units (GPUs), including optimizations in voltage regulator (VR) modules to increase power delivery efficiency.

### BRIEF DESCRIPTION OF THE DRAWINGS

In the drawings, like numerals may describe the same or similar components or features in different views. Like numerals having different letter suffixes may represent different instances of similar components. Some embodiments are illustrated by way of example, and not limitation, in the figures of the accompanying drawings listed below.

FIG. 1 is a block diagram of a power delivery architecture, in accordance with some embodiments.

FIG. 2 is a block diagram of a topology of a multi-module LEGO VR highlighting the first stage 2:1 switched capacitor (SC)-based voltage divider and the second stage buck VR, in accordance with some embodiments.

FIG. 3 illustrates a diagram of a multioutput VR topology constructed from the disclosed LEGO architecture, with at least one output rail feeding off all the modules and Vn voltages, in accordance with some embodiments.

FIG. 4 is a graph of operational waveforms (e.g., three output voltage rails) of a four-module 48V input multi-output VR using the LEGO architecture, in accordance with some embodiments.

FIG. 5 is a graph of operational waveforms (e.g., seven flying capacitor voltages) of a four-module 48V input multi-output VR using the LEGO architecture, in accordance with some embodiments.

FIG. 6 is a block diagram of a multi-output LEGO VR with a link converter that relaxes the constraint of having one output rail feed off all the modules, in accordance with some embodiments.

FIG. 7 is a block diagram of a multi-output LEGO VR with connected SC stage outputs of modules that do not share a common rail, which relaxes the constraint of having one output rail feed off all the modules, in accordance with some embodiments.

FIG. 8 and FIG. 9 illustrate diagrams of dynamic rail reconfigurability options through the splitting of the multi-phase modules in the second stage of the VR, in accordance with some embodiments.

FIG. 10 is a flow diagram of an example method for manufacturing a voltage regulator, in accordance with some embodiments.

FIG. 11 illustrates a block diagram of an example machine upon which any one or more of the operations/techniques (e.g., methodologies) discussed herein may perform.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

The following description and the drawings sufficiently illustrate specific embodiments to enable those skilled in the art to practice them. Other embodiments may incorporate structural, logical, electrical, process, and other changes. Portions and features of some embodiments may be included in or substituted for those of other embodiments. Embodiments outlined in the claims encompass all available equivalents of those claims.

As used herein, the term “chip” (or die) refers to a piece of a material, such as a semiconductor material, that includes a circuit, such as an integrated circuit or a part of an integrated circuit. The term “memory IP” indicates memory intellectual property. The terms “memory IP,” “memory device,” “memory chip,” and “memory” are interchangeable.

The term “a processor” configured to carry out specific operations includes both a single processor configured to carry out all of the operations (e.g., operations or methods disclosed herein) as well as multiple processors individually configured to carry out some or all of the operations (which may overlap) such that the combination of processors carry out all of the operations.

As used herein, the term “IO” indicates input/output. As used herein, the term “R-C” indicates resistance and capacitance. As used herein, the term “Rx” indicates receiver (or receive). As used herein, the term “Tx” indicates transmitter (or transmit). As used herein, the term “TRX” indicates transceiver. As used herein, the term “UCIe” indicates Universal Chiplet Interconnect Express. As used herein, the term “Vref” indicates reference voltage. As used herein, the term “Vin” indicates input voltage. As used herein, the terms “serially coupled,” “serially connected,” and “connected in series” are synonymous to each other and indicate a serial connection between two or more components/circuits where the serial connection can be based on a direct or indirect electrical connection between the two or more components/circuits. As used herein, the terms “parallel coupled,” “parallel connected,” and “connected in parallel” are synonymous to each other and indicate a parallel connection between two or more components/circuits where the parallel connection can be based on a direct or indirect electrical connection between the two or more components/circuits.

The disclosed techniques can be used to configure a consolidated VR module capable of producing multiple rails within a small footprint with high efficiency. In some aspects, the disclosed techniques can be used to configure a single output VR as a linear extendable group-operated (LEGO) VR to achieve high efficiency and density (e.g., due to its modularity and scalability). Several configurations of this VR as a multi-output converter are discussed herein below. The disclosed VR configurations retain the modularity, natural voltage balancing, and current sharing benefits of the single-output VR counterpart, thereby retaining the efficiency and density advantage of the converter as a multioutput VR.

Previous solutions use a dedicated VR for every rail required by the GPU platform. As the GPU's current requirement and number of required voltage rails continue to grow every generation, this solution ends up using too many discrete components, which, along with the component-to-component clearance constraints, lead to a suboptimal and grossly oversized power delivery footprint, exacerbating cost, complexity, and performance. Moreover, having dedicated VRs for every rail limits any scope for workload-specific dynamic performance enhancement opportunities due to limited communication between VR modules. Replacing all the dedicated VR modules with a consolidated multioutput VR can offer substantial benefits in terms of area, cost, and complexity while offering a significant performance boost.

To address the challenge of delivering greater than 1000 A of current to the GPU cores while supporting multiple other voltage rails in a small area, several topological variants of the LEGO VR that can serve as multi-output VRs are disclosed. LEGO VR, in its single-output form, can be used to achieve high efficiency and power density due to its modular construction, efficient switched capacitor stage, natural voltage balancing, and current sharing among its modules. The proposed topological variants for a multioutput VR use the same SC-based stage and only alter the second-stage converter, thus retaining all the key features that enable a high-efficiency and high-density multioutput power delivery solution.

The disclosed techniques can offer the following benefits:
(a) Significant consolidation and reduction in the overall power delivery footprint on the AI accelerator platforms;
(b) Greater end-to-end efficiency allowing improvement in performance and reduction in colling overhead;
(c) Improved signal routing and higher bandwidth; and
(d) Intelligent VR control opportunities to dynamically enhance efficiency.

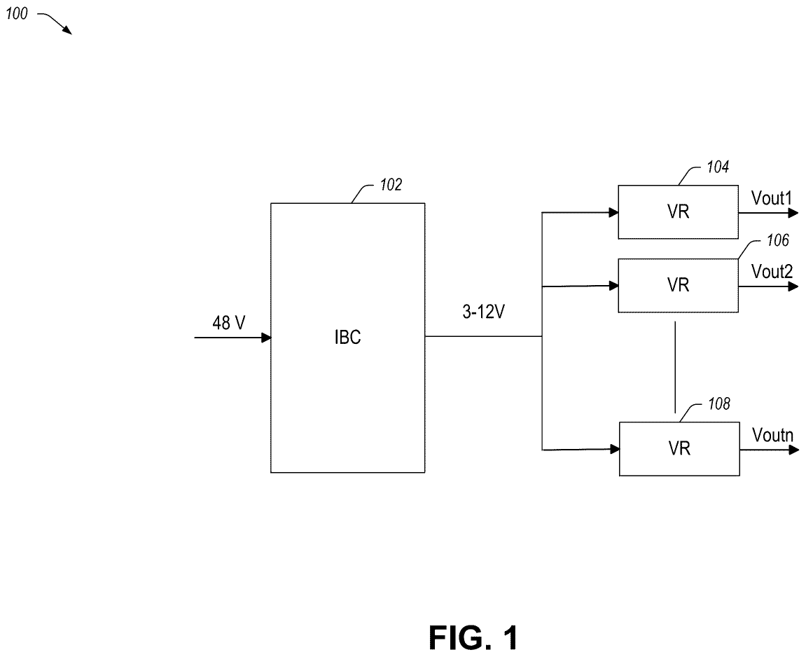

FIG. 1 is a block diagram of a power delivery architecture 100, in accordance with some embodiments. Referring to FIG. 1, the power delivery architecture 100 can be used in a server GPU platform and can include a front-end intermediate bus converter (IBC) 102 that steps down the 48V input to an intermediate voltage (e.g., 3-12V). The voltage rails required by the SoC are generated from this intermediate bus by using a dedicated voltage regulator (VR) for every rail (e.g., VRs 104, 106, . . . , 108). However, a drawback of this architecture is that it fails to sustain the ever-increasing GPU power and growing voltage rail count demand, which necessitates more consolidated and efficient power delivery solutions. The configuration of such a multioutput VR using the LEGO architecture is discussed below.

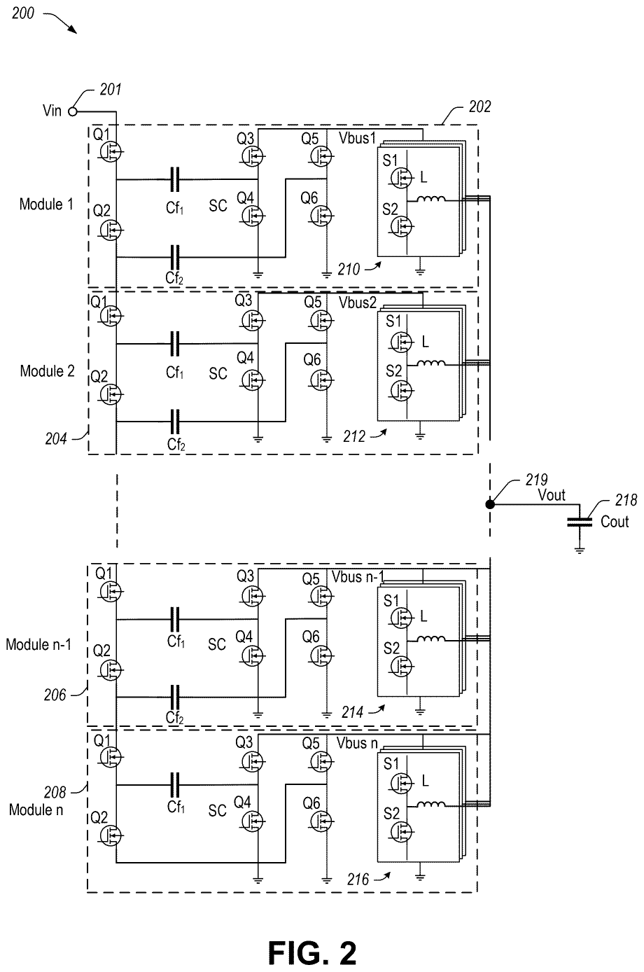

FIG. 2 is a block diagram of a topology 200 of a multi-module LEGO VR highlighting the first stage 2:1 switched capacitor (SC)-based voltage divider and the second stage buck VR, in accordance with some embodiments. Referring to FIG. 2, topology 200 is a single-output LEGO VR, including VR modules 1, 2, . . . , (n-1), and n. The VR modules comprise SC voltage divider circuits 202, 204, . . . , 206, and 208 that include input terminals (e.g., via transistors Q1) that are coupled in series with an input voltage terminal 201.

SC voltage divider circuits 202, 204, . . . , 206, and 208 generate corresponding intermediate voltage signals communicated on corresponding intermediate voltage rails Vbus1, Vbus2, . . . , Vbus(n-1), and Vbus(n). SC voltage divider circuits 202, 204, . . . , 206, and 208 are also coupled to corresponding voltage converter circuits 210, 212, . . . , 214, and 216 via the corresponding intermediate voltage rails Vbus1, Vbus2, . . . , Vbus(n-1), and Vbus(n).

In some aspects, outputs of the corresponding voltage converter circuits 210, 212, . . . , 214, and 216 are coupled in parallel to an output voltage terminal 219 and output capacitor 218.

In some aspects, each of the SC voltage divider circuits 202, 204, . . . , 206, and 208 includes transistors Q1-Q6 (e.g., NMOS transistors) and fly capacitors Cf1 and Cf2, all coupled as illustrated in FIG. 2.

In some aspects, each voltage converter circuit 210, 212, . . . , 214, and 216 can be configured as a buck VR or any other type of voltage converter, such as a step-up/step-down converter. In some aspects, each voltage converter circuit 210, 212, . . . , 214, and 216 can include transistors (e.g., transistors S1 and S2) coupled to an inductor L.

Even though the figures illustrate the voltage divider circuits and the voltage converter circuits configured with NMOS transistors, the disclosure is not limited in this regard, and other types of transistors can be used as well.

The modular architecture of the topology 200 allows it to scale to higher input voltages and output currents as the inputs of the modules are connected in series, and outputs of the VR modules are connected in parallel. As illustrated in FIG. 2, the first stage of each module is a 2:1 SC voltage divider, and the second stage is a multi-phase buck regulator. Other configurations of the VR modules can be used as well.

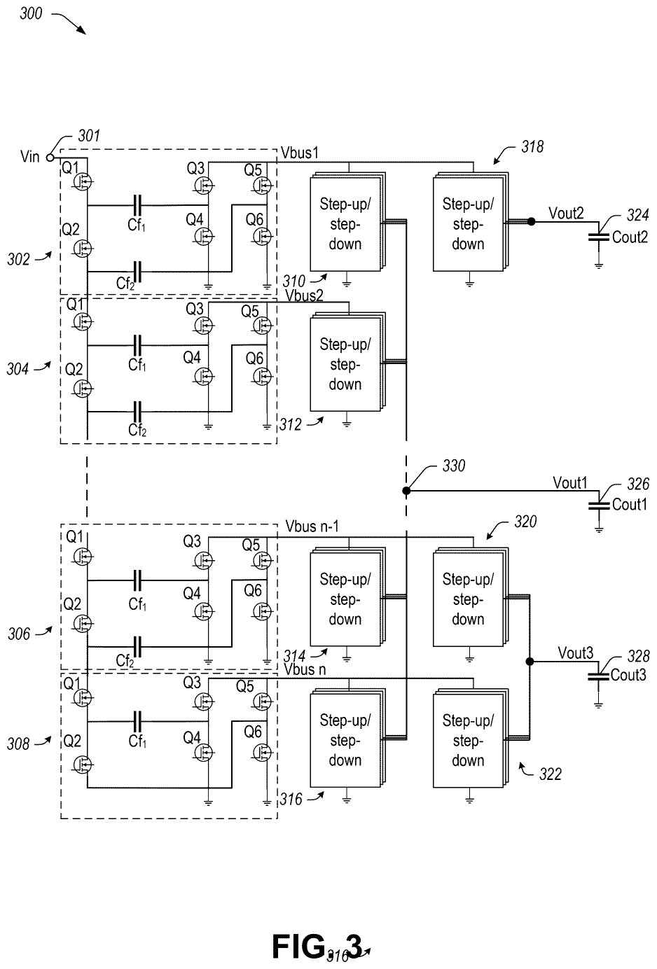

The topological variants of the LEGO VR that can support multiple outputs are discussed below (e.g., in connection with FIG. 3-FIG. 7).

FIG. 3 illustrates a diagram of a multioutput VR topology 300 constructed from the disclosed LEGO architecture, with at least one output rail feeding off all the modules and Vn voltages, in accordance with some embodiments. Referring to FIG. 3, topology 300 comprises SC voltage divider circuits 302, 304, . . . , 306, and 308 that include input terminals (e.g., via transistors Q1) that are coupled in series with an input voltage terminal 301.

SC voltage divider circuits 302, 304, . . . , 306, and 308 generate corresponding intermediate voltage signals communicated on corresponding intermediate voltage rails Vbus1, Vbus2, . . . , Vbus(n-1), and Vbus(n). SC voltage divider circuits 302, 304, . . . , 306, and 308 are also coupled to corresponding voltage converter circuits 310, 312, . . . , 314, and 316 via the corresponding intermediate voltage rails Vbus1, Vbus2, . . . , Vbus(n-1), and Vbus(n).

In some aspects, outputs of the corresponding voltage converter circuits 310, 312, . . . , 314, and 316 are coupled in parallel to an output voltage terminal 330 and output capacitor 326 to provide output voltage signal Vout1.

In some aspects, each of the SC voltage divider circuits 302, 304, . . . , 306, and 308 includes transistors Q1-Q6 (e.g., NMOS transistors) and fly capacitors Cf1 and Cf2, all coupled as illustrated in FIG. 3.

In some aspects, each voltage converter circuit 310, 312, . . . , 314, and 316 can be configured as a buck VR or any other type of voltage converter, such as a step-up/step-down converter.

In some aspects, additional voltage converter circuits can be coupled to one or more of the intermediate voltage rails to generate one or more additional output voltages. For example, and as illustrated in FIG. 3, voltage converter circuit 318 is coupled to intermediate voltage rail Vbus1 to generate output voltage Vout2 via output capacitor 324.

Additionally, voltage converter circuit 320 is coupled to intermediate voltage rail Vbus(n-1), and voltage converter circuit 322 is coupled to intermediate voltage rail Vbus(n). Voltage converter circuits 320 and 322 have parallel coupled outputs to generate output voltage Vout3 via output capacitor 328.

The topology 300 is configured with at least one output rail, and its second-stage VR is distributed across all the VR modules. As illustrated in FIG. 3, by having at least one output rail have its second stage VR distributed across all the modules (e.g., Vout1 rail in FIG. 3), all the intermediate bus and the flying capacitor voltages can be established. Once the Vout1 rail is generated in this fashion, the remaining rails can be generated from the intermediate bus voltages by distributing the corresponding second-stage VRs across as many modules as needed, depending on the output current and power stage size granularity of the rail.

For example, the Vout2 intermediate voltage rail is being generated from module 1 (e.g., SC voltage divider circuit 302 and voltage converter circuit 310), whereas Vout3 is being generated from modules (n-1) and n (the designation of VR modules can be similar to the designation in FIG. 2). This solution can be used in a typical GPU platform where the highest current core rail can be the primary rail (Vout1) that feeds off all the modules. The other low-current auxiliary rails can be generated from a subset of the modules.

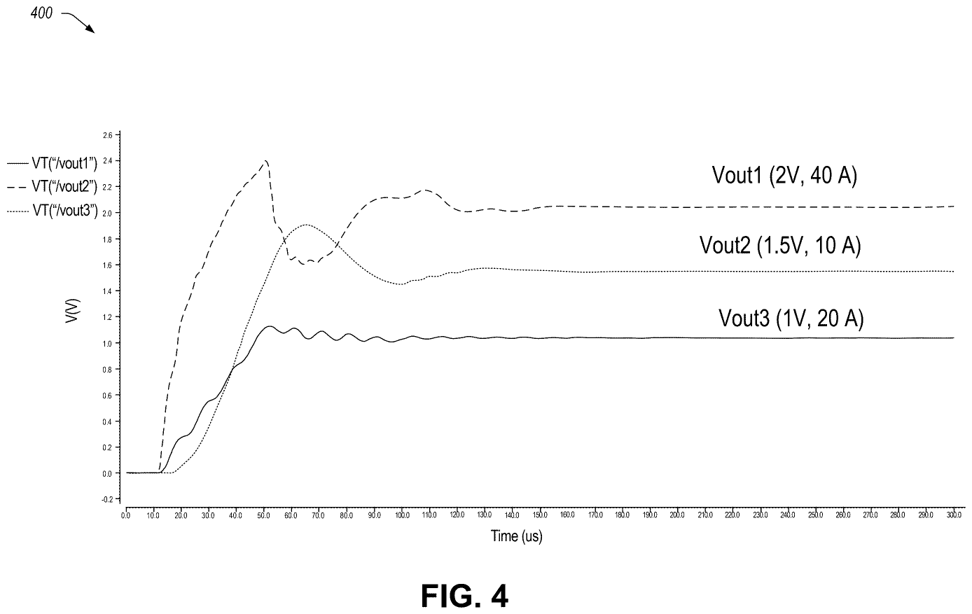

FIG. 4 is a graph 400 of operational waveforms (e.g., three output voltage rails) of a four-module 48V input multi-output VR using the LEGO architecture, in accordance with some embodiments.

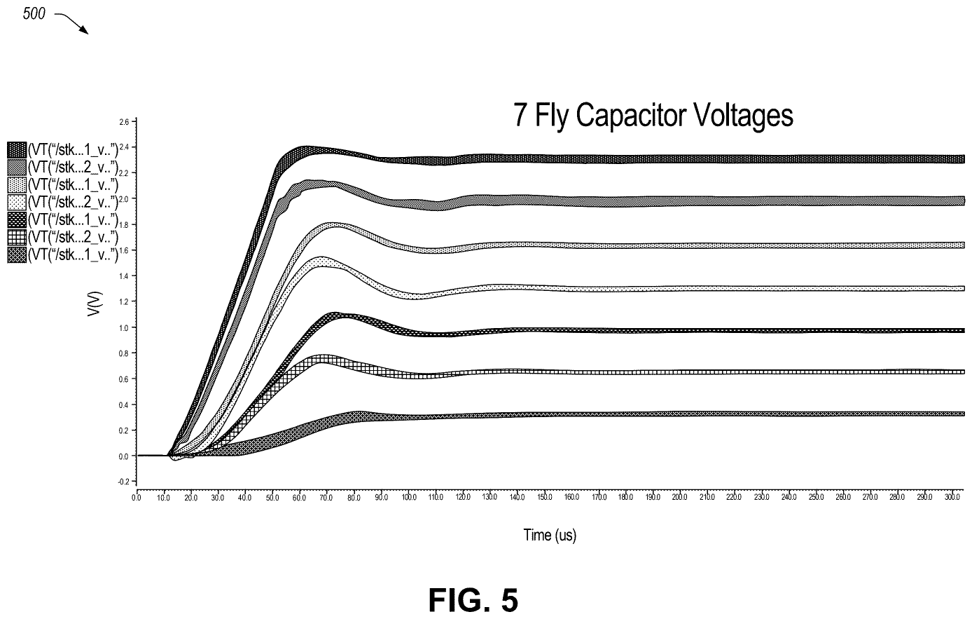

FIG. 5 is a graph 500 of operational waveforms (e.g., seven flying capacitor voltages) of a four-module 48V input multi-output VR using the LEGO architecture, in accordance with some embodiments.

More specifically, FIG. 4 and FIG. 5 illustrate key operational waveforms of an example four-module 48V input VR producing three voltage rails. It can be noted that the front-end SC stage's operation and performance are dictated by the total power consumed by all the rails and are agnostic to the auxiliary rail generation strategy used, thus retaining the benefits of the traditional single-output LEGO VR. Moreover, the switching frequency of operation of the second-stage VRs across different rails can be selected to be completely independent of each other, allowing for improved design and optimization.

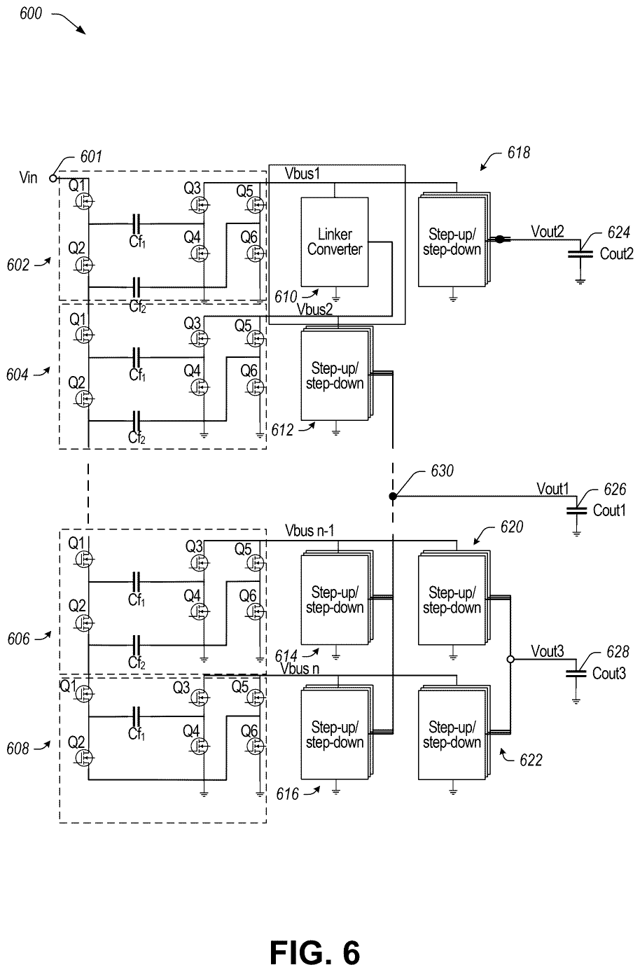

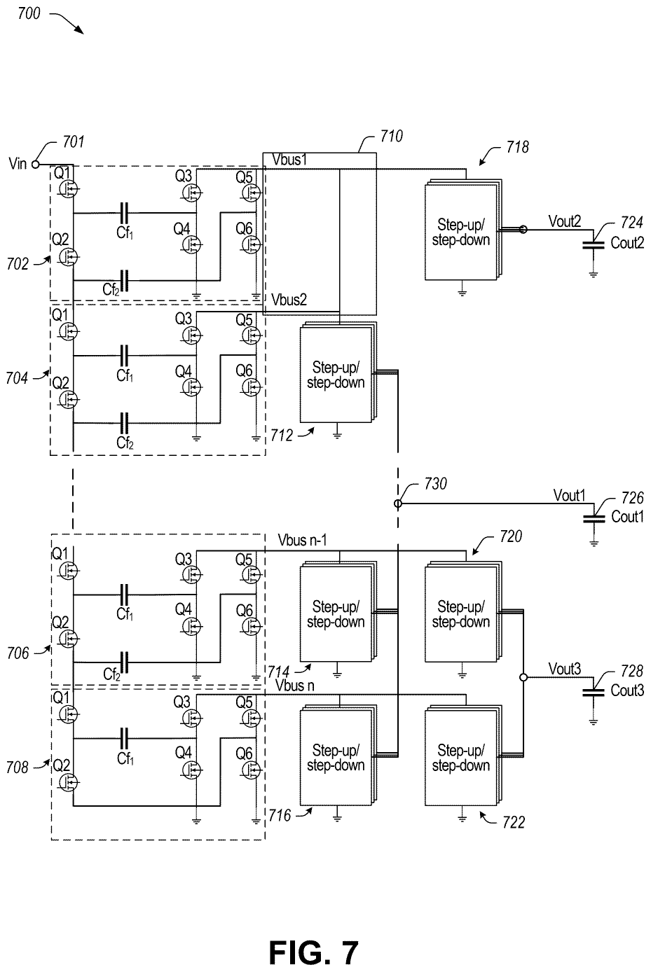

Example configurations used to configure the LEGO VR as a multioutput VR can include having a common link between the SC stage outputs of all the VR modules. In some aspects, this configuration can be accomplished in other ways that relax the constraint of having at least one rail generated from all modules. Two such example embodiments of the multioutput LEGO VR are illustrated in FIG. 6 and FIG. 7.

FIG. 6 is a block diagram of a multi-output LEGO VR topology 600 with a link converter that relaxes the constraint of having one output rail feed off all the modules, in accordance with some embodiments. Referring to FIG. 6, VR topology 600 comprises SC voltage divider circuits 602, 604, . . . , 606, and 608 that include input terminals (e.g., via transistors Q1) that are coupled in series with an input voltage terminal 601.

SC voltage divider circuits 602, 604, . . . , 606, and 608 generate corresponding intermediate voltage signals communicated on corresponding intermediate voltage rails Vbus1, Vbus2, . . . , Vbus(n-1), and Vbus(n). SC voltage divider circuits 602, 604, . . . , 606, and 608 are also coupled to corresponding voltage converter circuits 610, 612, . . . , 614, and 616 via the corresponding intermediate voltage rails Vbus1, Vbus2, . . . , Vbus(n-1), and Vbus(n).

In some aspects, outputs of the corresponding voltage converter circuits 610, 612, . . . , 614, and 616 are coupled in parallel to an output voltage terminal 630 and output capacitor 626 to provide output voltage signal Vout1.

In some aspects, each of the SC voltage divider circuits 602, 604, . . . , 606, and 608 includes transistors Q1-Q6 (e.g., NMOS transistors) and fly capacitors Cf1 and Cf2, all coupled as illustrated in FIG. 6.

In some aspects, each voltage converter circuit 610, 612, . . . , 614, and 616 can be configured as a buck VR or any other type of voltage converter, such as a step-up/step-down converter.

In some aspects, additional voltage converter circuits can be coupled to one or more of the intermediate voltage rails to generate one or more additional output voltages. For example, and as illustrated in FIG. 6, voltage converter circuit 618 is coupled to intermediate voltage rail Vbus1 to generate output voltage Vout2 via output capacitor 624.

Additionally, voltage converter circuit 620 is coupled to intermediate voltage rail Vbus(n-1), and voltage converter circuit 622 is coupled to intermediate voltage rail Vbus(n). Voltage converter circuits 620 and 622 have parallel coupled outputs to generate output voltage Vout3 via output capacitor 628.

In some aspects, a linker converter circuit can be used between modules that do not share a common rail. For example, a linker converter circuit can be placed between the SC stage outputs of modules that do not share a common rail to establish all the bus and flying capacitor voltages. This linker converter circuit can be realized using any step-up or step-down converter (e.g., buck, boost, or switched capacitor VR).

In some aspects, the voltage converter circuit 610 is configured as a linker converter circuit. As illustrated in FIG. 6, Vout1 is being generated from all the modules except the topmost one. Hence, a linker converter is placed between the topmost module and the remaining modules.

FIG. 7 is a block diagram of a multi-output LEGO VR with connected SC stage outputs of modules that do not share a common rail, which relaxes the constraint of having one output rail feed off all the modules, in accordance with some embodiments. Referring to FIG. 7, VR topology 700 comprises SC voltage divider circuits 702, 704, . . . , 706, and 708 that include input terminals (e.g., via transistors Q1) that are coupled in series with an input voltage terminal 701.

SC voltage divider circuits 702, 704, . . . , 706, and 708 generate corresponding intermediate voltage signals communicated on corresponding intermediate voltage rails Vbus1, Vbus2, . . . , Vbus(n-1), and Vbus(n). SC voltage divider circuits 602, 604, . . . , 606, and 608 are also coupled to corresponding circuit 710 and voltage converter circuits 712, . . . , 714, and 716 via the corresponding intermediate voltage rails Vbus1, Vbus2, . . . , Vbus(n-1), and Vbus(n).

In some aspects, outputs of the corresponding voltage converter circuits 712, . . . , 714, and 716 are coupled in parallel to an output voltage terminal 730 and output capacitor 726 to provide output voltage signal Vout1.

In some aspects, each of the SC voltage divider circuits 702, 704, . . . , 706, and 708 includes transistors Q1-Q6 (e.g., NMOS transistors) and fly capacitors Cf1 and Cf2, all coupled as illustrated in FIG. 7.

In some aspects, each voltage converter circuit 712, . . . , 714, and 716 can be configured as a buck VR or any other type of voltage converter, such as a step-up/step-down converter.

In some aspects, additional voltage converter circuits can be coupled to one or more of the intermediate voltage rails to generate one or more additional output voltages. For example, and as illustrated in FIG. 7, voltage converter circuit 718 is coupled to intermediate voltage rail Vbus1 to generate output voltage Vout2 via output capacitor 724.

Additionally, voltage converter circuit 720 is coupled to intermediate voltage rail Vbus(n-1), and voltage converter circuit 722 is coupled to intermediate voltage rail Vbus(n). Voltage converter circuits 720 and 722 have parallel coupled outputs to generate output voltage Vout3 via output capacitor 728.

In some aspects, topology 700 is configured based on connecting the SC stage outputs of modules that do not share a common rail. More specifically, instead of having a linker converter, the SC stage outputs can be tied together to achieve the same functionality. For example, and as illustrated in FIG. 7, circuit 710 is configured to provide a coupling connection between intermediate voltage rails Vbus1 and Vbus2, which connection is also coupled to voltage converter circuit 712. In some aspects, the simplicity of this approach comes with efficiency loss due to the hard-charging of the flying capacitors among modules.

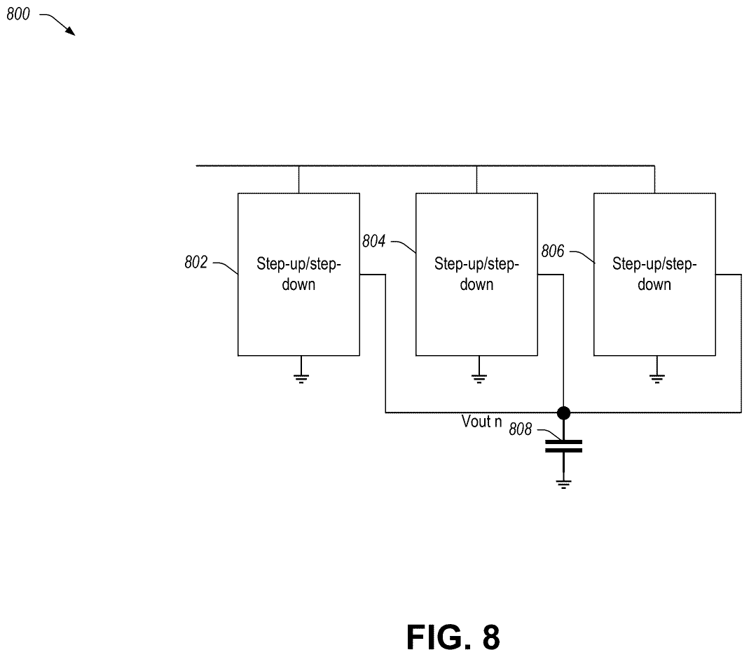

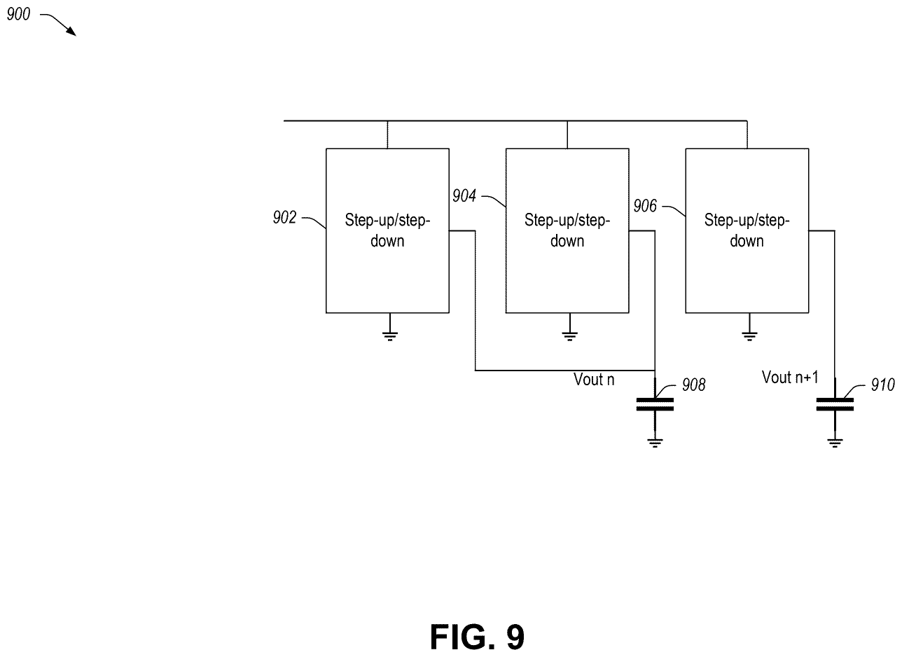

In some aspects, the disclosed techniques include dynamic rail reconfigurability (e.g., as illustrated in FIG. 8 and FIG. 9). In some aspects, the multi-phase units in the second stage of any given module can be merged to feed to a common output rail or can be split between multiple rails as needed.

FIG. 8 and FIG. 9 illustrate diagrams of dynamic rail reconfigurability options through the splitting of the multi-phase modules in the second stage of the VR, in accordance with some embodiments. Referring to FIG. 8, topology 800 includes voltage converter circuits 802, 804, and 806, each having its output voltage rail coupled to output capacitor 808.

Referring to FIG. 9, topology 900 includes voltage converter circuits 902, 904, and 906. The output voltage rails of voltage converter circuits 902 and 904 are coupled to output capacitor 908, and the output voltage rail of the voltage converter circuit 906 is coupled to output capacitor 910.

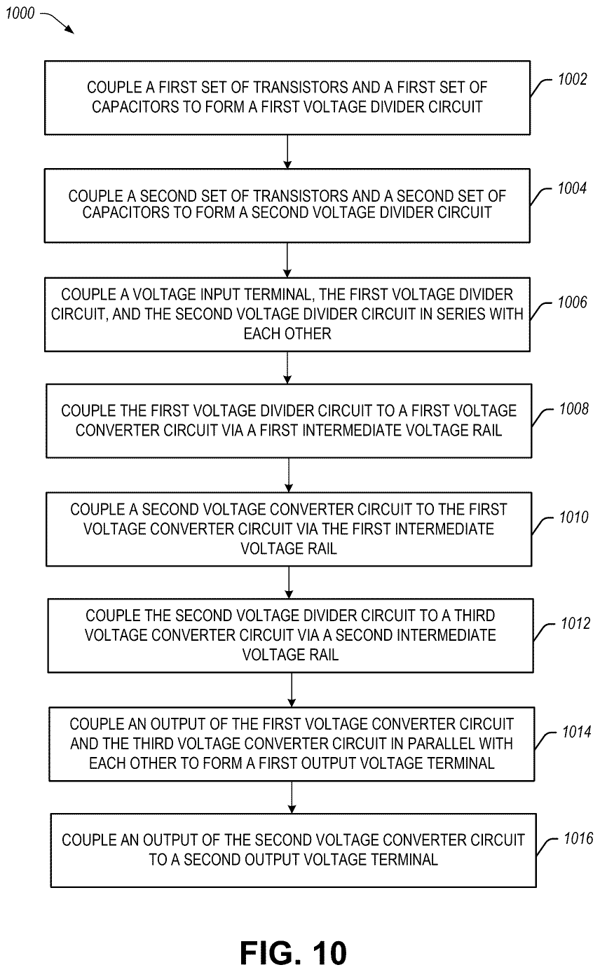

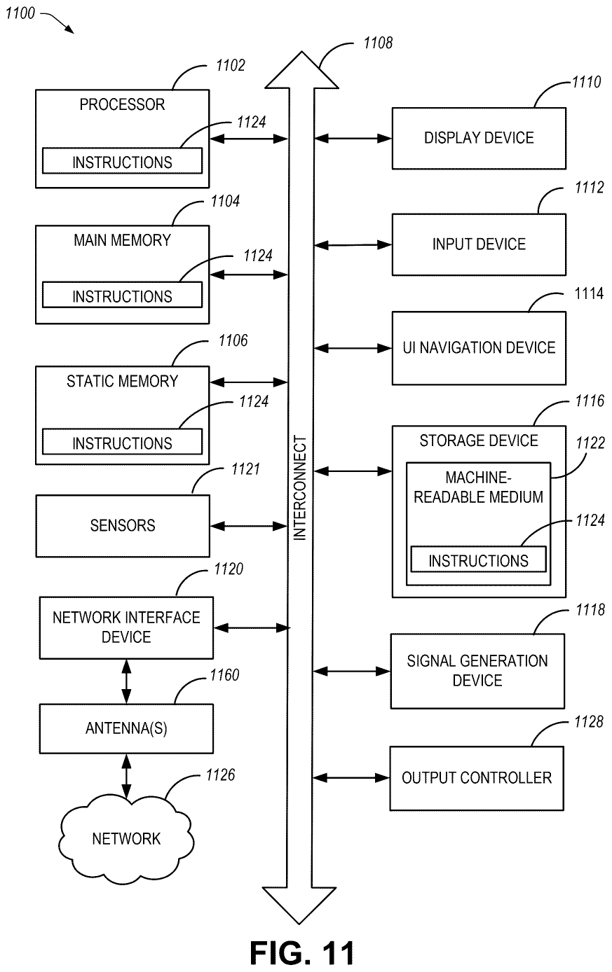

FIG. 10 is a flow diagram of an example method 1000 for manufacturing a voltage regulator, in accordance with some embodiments. Referring to FIG. 10, method 1000 includes operations 1002, 1004, 1006, 1008, 1010, 1012, 1014, and 1016, which may be executed by a processor, an embedded controller, a receiver circuit, a transceiver circuit, or another processor of a computing device (e.g., hardware processor 1102 of machine 1100 illustrated in FIG. 11, which can include one or more of the circuits discussed in connection with FIGS. 1-9). In some embodiments, one or more of the circuits discussed in connection with FIGS. 1-9 can perform the functionalities (or include the configurations or circuitry) associated with FIG. 10, as well as one or more of the examples listed below.

At operation 1002, a first set of transistors and a first set of capacitors are coupled to form a first voltage divider circuit.

At operation 1004, coupling a second set of transistors and a second set of capacitors to form a second voltage divider circuit.

At operation 1006, coupling a voltage input terminal, the first voltage divider circuit, and the second voltage divider circuit in series with each other.

At operation 1008, coupling the first voltage divider circuit to a first voltage converter circuit via a first intermediate voltage rail.

At operation 1010, coupling a second voltage converter circuit to the first voltage converter circuit via the first intermediate voltage rail

At operation 1012, coupling the second voltage divider circuit to a third voltage converter circuit via a second intermediate voltage rail.

At operation 1014, coupling an output of the first voltage converter circuit and the third voltage converter circuit in parallel with each other to form a first output voltage terminal.

At operation 1016, coupling an output of the second voltage converter circuit to a second output voltage terminal.

FIG. 11 illustrates a block diagram of an example machine 1100 upon which any one or more of the techniques (e.g., methodologies) discussed herein may perform. In alternative embodiments, the machine 1100 may operate as a standalone device or may be connected (e.g., networked) to other machines. In a networked deployment, machine 1100 may operate in the capacity of a server machine, a client machine, or both in server-client network environments. In an example, machine 1100 may function as a peer machine in a peer-to-peer (P2P) (or other distributed) network environment. Machine 1100 may be a personal computer (PC), a tablet PC, a set-top box (STB), a personal digital assistant (PDA), a portable communications device, a mobile telephone, a smartphone, a web appliance, a network router, switch or bridge, or any other computing device capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. The terms “machine,” “computing device,” and “computer system” are used interchangeably.

Machine (e.g., computer system) 1100 may include a hardware processor 1102 (e.g., a central processing unit (CPU), a graphics processing unit (GPU), a hardware processor core, or any combination thereof), a main memory 1104, and a static memory 1106, some or all of which may communicate with each other via an interlink (e.g., bus) 1108. In some aspects, the main memory 1104, the static memory 1106, or any other type of memory (including cache memory) used by machine 1100 can be configured based on the disclosed techniques or can implement the disclosed memory devices.

Specific examples of main memory 1104 include Random Access Memory (RAM) and semiconductor memory devices, which may include, in some embodiments, storage locations in semiconductors such as registers. Specific examples of static memory 1106 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

Machine 1100 may further include a display device 1110, an input device 1112 (e.g., a keyboard), and a user interface (UI) navigation device 1114 (e.g., a mouse). In an example, the display device 1110, the input device 1112, and the UI navigation device 1114 may be a touchscreen display. Machine 1100 may additionally include a storage device (e.g., drive unit or another mass storage device) 1116, a signal generation device 1118 (e.g., a speaker), a network interface device 1120, and one or more sensors 1121, such as a global positioning system (GPS) sensor, compass, accelerometer, or other sensors. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments, the hardware processor 1102 and/or instructions 1124 may comprise processing circuitry and/or transceiver circuitry.

The storage device 1116 may include a machine-readable medium 1122 on which one or more sets of data structures or instructions 1124 (e.g., software) embodying or utilized by any one or more of the techniques or functions described herein can be stored. Instructions 1124 may also reside, completely or at least partially, within the main memory 1104, within static memory 1106, or the hardware processor 1102 during execution thereof by machine 1100. In an example, one or any combination of the hardware processor 1102, the main memory 1104, the static memory 1106, or the storage device 1116 may constitute machine-readable media.

Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine-readable medium 1122 is illustrated as a single medium, the term “machine-readable medium” may include a single medium or multiple media (e.g., a centralized or distributed database and/or associated caches and servers) configured to store instructions 1124.

An apparatus of machine 1100 may be one or more of a hardware processor 1102 (e.g., a central processing unit (CPU), a graphics processing unit (GPU), a hardware processor core, or any combination thereof), a main memory 1104 and a static memory 1106, one or more sensors 1121, a network interface device 1120, one or more antennas 1160, a display device 1110, an input device 1112, a UI navigation device 1114, a storage device 1116, instructions 1124, a signal generation device 1118, and an output controller 1128. The apparatus may be configured to perform one or more of the methods and/or operations disclosed herein. The apparatus may be intended as a component of machine 1100 to perform one or more of the methods and/or operations disclosed herein and/or to perform a portion of one or more of the methods and/or operations disclosed herein. In some embodiments, the apparatus may include a pin or other means to receive power. In some embodiments, the apparatus may include power conditioning hardware.

The term “machine-readable medium” may include any medium that is capable of storing, encoding, or carrying instructions for execution by machine 1100 and that causes machine 1100 to perform any one or more of the techniques of the present disclosure or that is capable of storing, encoding, or carrying data structures used by or associated with such instructions. Non-limiting machine-readable medium examples may include solid-state memories and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine-readable media may include non-transitory machine-readable media. In some examples, machine-readable media may include machine-readable media that is not a transitory propagating signal.

The instructions 1124 may further be transmitted or received over a communications network 1126 using a transmission medium via the network interface device 1120 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.8.4 family of standards, a Long Term Evolution (LTE) family of standards, a Universal Mobile Telecommunications System (UMTS) family of standards, peer-to-peer (P2P) networks, among others.

In an example, the network interface device 1120 may include one or more physical jacks (e.g., Ethernet, coaxial, or phone jacks) or one or more antennas to connect to the communications network 1126. In an example, the network interface device 1120 may include one or more antennas 1160 to wirelessly communicate using at least one single-input multiple-output (SIMO), multiple-input multiple-output (MIMO), or multiple-input single-output (MISO) techniques. In some examples, the network interface device 1120 may wirelessly communicate using multiple-user MIMO techniques. The term “transmission medium” shall be taken to include any intangible medium that can store, encode, or carry instructions for execution by machine 1100 and includes digital or analog communications signals or other intangible media to facilitate communication of such software.

Examples, as described herein, may include, or may operate on, logic or several components, modules, or mechanisms. Modules are tangible entities (e.g., hardware) capable of performing specified operations and may be configured or arranged in a particular manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part, all, or any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at separate times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM), random access memory (RAM), magnetic disk storage media, optical storage media, flash memory, etc.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, examples that include the elements shown or described are also contemplated. Moreover, also contemplated are examples using any combination or permutation of those elements shown or described (or one or more aspects thereof), either with respect to a particular example (or one or more aspects thereof) or with respect to other examples (or one or more aspects thereof) shown or described herein.

Publications, patents, and patent documents referred to in this document are incorporated by reference herein in their entirety, as though individually incorporated by reference. In the event of inconsistent usage between this document and those documents so incorporated by reference, the usage in the incorporated reference(s) is supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc., are used merely as labels and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in several environments, such as part of a system on chip, a set of intercommunicating functional blocks, or similar, although the scope of the disclosure is not limited in this respect.

Described implementations of the subject matter can include one or more features, alone or in combination, as illustrated below by way of examples.
Example 1 is an apparatus (e.g., a voltage regulator (VR) circuit) comprising: a first NMOS transistor comprising a drain terminal coupled to an input voltage terminal supplying an input voltage signal and a source terminal coupled to a first capacitor; a second NMOS transistor comprising a drain terminal coupled to the source terminal of the first NMOS transistor and a source terminal coupled to a second capacitor; a third NMOS transistor comprising a source terminal coupled to the first capacitor and a drain terminal coupled to a first intermediate voltage rail; a fourth NMOS transistor comprising a drain terminal coupled to the source terminal of the third NMOS transistor and a source terminal coupled to a ground terminal; a fifth NMOS transistor comprising a drain terminal coupled to the first intermediate voltage rail and a source terminal coupled to the second capacitor; a sixth NMOS transistor comprising a drain terminal coupled to the source terminal of the fifth NMOS transistor and a source terminal coupled to the ground terminal; and a plurality of output voltage rails coupled to the first intermediate voltage rail.
In Example 2, the subject matter of Example 1 includes a first voltage converter circuit coupled between the first intermediate voltage rail and a first output voltage terminal associated with the plurality of output voltage rails.
In Example 3, the subject matter of Example 2 includes a second voltage converter circuit coupled between the first intermediate voltage rail and a second output voltage terminal associated with the plurality of output voltage rails.
In Example 4, the subject matter of Example 3 includes a seventh NMOS transistor comprising a drain terminal coupled to the input voltage terminal supplying the input voltage signal and a source terminal coupled to a third capacitor, and an eighth NMOS transistor comprising a drain terminal coupled to the source terminal of the seventh NMOS transistor and a source terminal coupled to a fourth capacitor.
In Example 5, the subject matter of Example 4 includes a ninth NMOS transistor comprising a source terminal coupled to the third capacitor and a drain terminal coupled to a second intermediate voltage rail and a tenth NMOS transistor comprising a drain terminal coupled to the source terminal of the ninth NMOS transistor and a source terminal coupled to the ground terminal.
In Example 6, the subject matter of Example 5 includes an eleventh NMOS transistor comprising a drain terminal coupled to the second intermediate voltage rail and a source terminal coupled to the fourth capacitor, and a twelfth NMOS transistor comprising a drain terminal coupled to the source terminal of the eleventh NMOS transistor and a source terminal coupled to the ground terminal.
In Example 7, the subject matter of Example 6 includes a third voltage converter circuit coupled between the second intermediate voltage rail and the first output voltage terminal.
In Example 8, the subject matter of Example 7 includes one or more additional voltage converter circuits coupled in parallel between one or more additional intermediate voltage rails and the first output voltage terminal.
In Example 9, the subject matter of Example 8 includes subject matter such as each of the one or more additional voltage converter circuits comprising a pair of NMOS transistors coupled in series with each other and an inductor coupled to the pair of NMOS transistors and the first output voltage terminal.
In Example 10, the subject matter of Examples 7-9 includes a linker converter circuit coupled between the first intermediate voltage rail and the second intermediate voltage rail.
In Example 11, the subject matter of Examples 7-10 includes subject matter such as the third voltage converter circuit being coupled to the second voltage converter circuit.
In Example 12, the subject matter of Examples 6-11 includes subject matter such as the apparatus comprising a system-on-chip (SoC), the SoC comprising an integrated circuit (IC), the IC comprising the first voltage converter circuit, the second voltage converter circuit, and at least two transistors of the first NMOS transistor through the twelfth NMOS transistor.
In Example 13, the subject matter of Example 12 includes subject matter such as the SoC further comprises at least one connector, wherein the at least one connector conforms with at least one of Universal Serial Bus (USB), High-Definition Multimedia Interface (HDMI), Thunderbolt, Peripheral Component Interconnect Express (PCIe), and Ethernet specifications.
Example 14 is an apparatus comprising a first voltage divider circuit coupled to an input voltage terminal supplying an input voltage signal, the first voltage divider circuit to generate a first intermediate voltage signal based on the input voltage signal; a first voltage converter circuit coupled to the first voltage divider circuit, the first voltage converter circuit to: generate a first output voltage signal based on the first intermediate voltage signal; and supply the first output voltage signal to a first output voltage terminal; and a second voltage converter circuit coupled to the first voltage divider circuit and the first voltage converter circuit, the second voltage converter circuit to generate a second output voltage signal on a second output voltage terminal based on the first intermediate voltage signal.
In Example 15, the subject matter of Example 14 includes subject matter such as the first voltage divider circuit comprises: a first NMOS transistor comprising a drain terminal coupled to the input voltage terminal supplying the input voltage signal and a source terminal coupled to a first capacitor; a second NMOS transistor comprising a drain terminal coupled to the source terminal of the first NMOS transistor and a source terminal coupled to a second capacitor; a third NMOS transistor comprising a source terminal coupled to the first capacitor and a drain terminal coupled to a first intermediate voltage rail supplying the first intermediate voltage signal; a fourth NMOS transistor comprising a drain terminal coupled to the source terminal of the third NMOS transistor and a source terminal coupled to a ground terminal; a fifth NMOS transistor comprising a drain terminal coupled to the first intermediate voltage rail and a source terminal coupled to the second capacitor; and a sixth NMOS transistor comprising a drain terminal coupled to the source terminal of the fifth NMOS transistor and a source terminal coupled to the ground terminal.
In Example 16, the subject matter of Examples 14-15 includes a second voltage divider circuit coupled to the input voltage terminal supplying the input voltage signal, the second voltage divider circuit to generate a second intermediate voltage signal based on the input voltage signal; and a third voltage converter circuit coupled to the second voltage divider circuit, the third voltage converter circuit is to generate the first output voltage signal based on the second intermediate voltage signal.
In Example 17, the subject matter of Example 16 includes subject matter such as the first voltage divider circuit comprises a first input terminal, wherein the second voltage divider circuit comprises a second input terminal, and wherein the first input terminal and the second input terminal are coupled in series with each other and with the input voltage terminal.
In Example 18, the subject matter of Examples 16-17 includes subject matter such as output terminals of the first voltage converter circuit and the third voltage converter circuit are coupled in parallel with each other and supply the first output voltage signal to a first output voltage terminal.
In Example 19, the subject matter of Examples 14-18 includes subject matter such as the first voltage converter circuit is a linker converter circuit.
Example 20 is a process of making a voltage regulator (VR) circuit, comprising: coupling a first set of transistors and a first set of capacitors to form a first voltage divider circuit; coupling a second set of transistors and a second set of capacitors to form a second voltage divider circuit; coupling a voltage input terminal, the first voltage divider circuit, and the second voltage divider circuit in series with each other; coupling the first voltage divider circuit to a first voltage converter circuit via a first intermediate voltage rail; coupling a second voltage converter circuit to the first voltage converter circuit via the first intermediate voltage rail; coupling the second voltage divider circuit to a third voltage converter circuit via a second intermediate voltage rail; coupling an output of the first voltage converter circuit and the third voltage converter circuit in parallel with each other to form a first output voltage terminal; and coupling an output of the second voltage converter circuit to a second output voltage terminal.
Example 21 is at least one machine-readable medium including instructions that, when executed by processing circuitry, cause the processing circuitry to perform operations to implement any of Examples 1-20.
Example 22 is an apparatus comprising means to implement any of Examples 1-20.
Example 23 is a system to implement any of Examples 1-20.
Example 24 is a method to implement any of Examples 1-20.

The above description is intended to be illustrative and not restrictive. For example, the above-described examples (or one or more aspects thereof) may be used in combination with others. Other embodiments may be used, such as by one of ordinary skill in the art upon reviewing the above description. The abstract is to allow the reader to ascertain the nature of the technical disclosure quickly. It is submitted with the understanding that it will not be used to interpret or limit the scope or meaning of the claims. Also, in the above Detailed Description, various features may be grouped to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined regarding the appended claims, along with the full scope of equivalents to which such claims are entitled.

What is claimed is:

1. An apparatus comprising:
a first NMOS transistor comprising a drain terminal coupled to an input voltage terminal supplying an input voltage signal and a source terminal coupled to a first capacitor;
a second NMOS transistor comprising a drain terminal coupled to the source terminal of the first NMOS transistor and a source terminal coupled to a second capacitor;
a third NMOS transistor comprising a source terminal coupled to the first capacitor and a drain terminal coupled to a first intermediate voltage rail;
a fourth NMOS transistor comprising a drain terminal coupled to the source terminal of the third NMOS transistor and a source terminal coupled to a ground terminal;
a fifth NMOS transistor comprising a drain terminal coupled to the first intermediate voltage rail and a source terminal coupled to the second capacitor;
a sixth NMOS transistor comprising a drain terminal coupled to the source terminal of the fifth NMOS transistor and a source terminal coupled to the ground terminal; and
a plurality of output voltage rails coupled to the first intermediate voltage rail.

2. The apparatus of claim 1, further comprising:
a first voltage converter circuit coupled between the first intermediate voltage rail and a first output voltage terminal associated with the plurality of output voltage rails.

3. The apparatus of claim 2, further comprising:
a second voltage converter circuit coupled between the first intermediate voltage rail and a second output voltage terminal associated with the plurality of output voltage rails.

4. The apparatus of claim 3, further comprising:
a seventh NMOS transistor comprising a drain terminal coupled to the input voltage terminal supplying the input voltage signal and a source terminal coupled to a third capacitor; and
an eighth NMOS transistor comprising a drain terminal coupled to the source terminal of the seventh NMOS transistor and a source terminal coupled to a fourth capacitor.

5. The apparatus of claim 4, further comprising:
a ninth NMOS transistor comprising a source terminal coupled to the third capacitor and a drain terminal coupled to a second intermediate voltage rail; and
a tenth NMOS transistor comprising a drain terminal coupled to the source terminal of the ninth NMOS transistor and a source terminal coupled to the ground terminal.

6. The apparatus of claim 5, further comprising:
an eleventh NMOS transistor comprising a drain terminal coupled to the second intermediate voltage rail and a source terminal coupled to the fourth capacitor; and
a twelfth NMOS transistor comprising a drain terminal coupled to the source terminal of the eleventh NMOS transistor and a source terminal coupled to the ground terminal.

7. The apparatus of claim 6, further comprising:
a third voltage converter circuit coupled between the second intermediate voltage rail and the first output voltage terminal.

8. The apparatus of claim 7, further comprising:
one or more additional voltage converter circuits coupled in parallel between one or more additional intermediate voltage rails and the first output voltage terminal.

9. The apparatus of claim 8, wherein each of the one or more additional voltage converter circuits comprises:
a pair of NMOS transistors coupled in series with each other; and
an inductor coupled to the pair of NMOS transistors and the first output voltage terminal.

10. The apparatus of claim 7, further comprising:
a linker converter circuit coupled between the first intermediate voltage rail and the second intermediate voltage rail.

11. The apparatus of claim 7, wherein the third voltage converter circuit is coupled to the second voltage converter circuit.

12. The apparatus of claim 6, the apparatus comprising:
a system-on-chip (SoC), the SoC comprising an integrated circuit (IC), the IC comprising the first voltage converter circuit, the second voltage converter circuit, and at least two transistors of the first NMOS transistor through the twelfth NMOS transistor.

13. The apparatus of claim 12, wherein the SoC further comprises at least one connector, and wherein the at least one connector conforms with at least one of Universal Serial Bus (USB), High-Definition Multimedia Interface (HDMI), Thunderbolt, Peripheral Component Interconnect Express (PCIe), and Ethernet specifications.

14. An apparatus comprising:
a first voltage divider circuit coupled to an input voltage terminal supplying an input voltage signal, the first voltage divider circuit to generate a first intermediate voltage signal based on the input voltage signal;
a first voltage converter circuit coupled to the first voltage divider circuit, the first voltage converter circuit to:
generate a first output voltage signal based on the first intermediate voltage signal; and
supply the first output voltage signal to a first output voltage terminal; and
a second voltage converter circuit coupled to the first voltage divider circuit and the first voltage converter circuit, the second voltage converter circuit to generate a second output voltage signal on a second output voltage terminal based on the first intermediate voltage signal.

15. The apparatus of claim 14, wherein the first voltage divider circuit comprises:
a first NMOS transistor comprising a drain terminal coupled to the input voltage terminal supplying the input voltage signal and a source terminal coupled to a first capacitor;
a second NMOS transistor comprising a drain terminal coupled to the source terminal of the first NMOS transistor and a source terminal coupled to a second capacitor;
a third NMOS transistor comprising a source terminal coupled to the first capacitor and a drain terminal coupled to a first intermediate voltage rail supplying the first intermediate voltage signal;
a fourth NMOS transistor comprising a drain terminal coupled to the source terminal of the third NMOS transistor and a source terminal coupled to a ground terminal;
a fifth NMOS transistor comprising a drain terminal coupled to the first intermediate voltage rail and a source terminal coupled to the second capacitor; and
a sixth NMOS transistor comprising a drain terminal coupled to the source terminal of the fifth NMOS transistor and a source terminal coupled to the ground terminal.

16. The apparatus of claim 14, further comprising:
a second voltage divider circuit coupled to the input voltage terminal supplying the input voltage signal, the second voltage divider circuit to generate a second intermediate voltage signal based on the input voltage signal; and
a third voltage converter circuit coupled to the second voltage divider circuit, the third voltage converter circuit is to generate the first output voltage signal based on the second intermediate voltage signal.

17. The apparatus of claim 16, wherein the first voltage divider circuit comprises a first input terminal, wherein the second voltage divider circuit comprises a second input terminal, and wherein the first input terminal and the second input terminal are coupled in series with each other and with the input voltage terminal.

18. The apparatus of claim 16, wherein output terminals of the first voltage converter circuit and the third voltage converter circuit are coupled in parallel with each other and supply the first output voltage signal to a first output voltage terminal.

19. The apparatus of claim 14, wherein the first voltage converter circuit is a linker converter circuit.

20. A process of making a voltage regulator (VR) circuit, comprising:
coupling a first set of transistors and a first set of capacitors to form a first voltage divider circuit;
coupling a second set of transistors and a second set of capacitors to form a second voltage divider circuit;
coupling a voltage input terminal, the first voltage divider circuit, and the second voltage divider circuit in series with each other;
coupling the first voltage divider circuit to a first voltage converter circuit via a first intermediate voltage rail;
coupling a second voltage converter circuit to the first voltage converter circuit via the first intermediate voltage rail;
coupling the second voltage divider circuit to a third voltage converter circuit via a second intermediate voltage rail;
coupling an output of the first voltage converter circuit and the third voltage converter circuit in parallel with each other to form a first output voltage terminal; and
coupling an output of the second voltage converter circuit to a second output voltage terminal.
